(19) United States
(12) Patent Application Publication
(10) Pub. No.: US 2025/0304408 A1
(43) Pub. Date: Oct. 2, 2025

(54) METHOD AND SYSTEM FOR INTELLIGENT TRANSPORT SYSTEM (ITS)

(71) Applicant: Lenovo (Singapore) Pte. Ltd., New Tech Park (SG)

(72) Inventors: Munjalkumar Chimanbhai Patel, Cary, NC (US); Egbert Jose Gracias, Raleigh, NC (US)

(21) Appl. No.: 18/622,631

(22) Filed: Mar. 29, 2024

(51) Int. Cl. B66B 1/24; B66B 5/00; G06V 10/82; G06V 40/10

(52) U.S. Cl. CPC B66B 1/2466; B66B 5/0012; G06V 10/82; G06V 40/10; B66B 2201/212; B66B 2201/235; B66B 2201/243

(57) ABSTRACT

A method, apparatus, and computer program product for protecting electronic devices from obstructed voice commands. The method includes receiving, from one or more sensors, sensor data associated with an elevator car and training an artificial intelligence (“AI”) model with a set of preset parameters, archived data from the one or more sensors and corresponding archived data depicting a historical route traveled by the elevator car. The method includes determining, via the AI model, a route for the elevator car based at least in part on the sensor data, wherein the determined route is a shortest route that satisfies the set of preset parameters and transporting the elevator car according to the determined route.

### FIELD

The subject matter disclosed herein relates to elevator systems and more particularly relates to determining an optimal route for an elevator car.

### BACKGROUND

Modern commercial elevators are inefficient. Often once dispatched, they cannot be recalled. This results in unnecessary stops at floors where passengers who called cars are no longer waiting, passengers are forced to travel to floors they no longer wish to visit and other scenarios where the time of passengers is wasted. Moreover, options for getting help to passengers in the event of an emergency are limited.

### BRIEF SUMMARY

A method for determining an optimal route for an elevator car is disclosed. A computer program product and a system also perform the functions of the method. According to a first aspect of the disclosure, the method includes receiving, from one or more sensors, sensor data associated with the elevator car. The method includes training an artificial intelligence (“AI”) model with a set of preset parameters, archived data from the one or more sensors and corresponding archived data depicting one or more historical routes traveled by the elevator car. The method includes determining, via the AI model, a route for the elevator car based at least in part on the sensor data, wherein the determined route is the shortest route that satisfies all preset parameters. The method includes transporting the elevator car according to the determined route.

According to another aspect of the present disclosure, a control system that uses AI to choose an optimal route for an elevator car is disclosed. The control system includes a processor and non-transitory computer readable storage media storing code. The code is executable by the processor to perform operations that include receiving, from one or more sensors, sensor data associated with an elevator car. The operations include training an AI model with a set of preset parameters, archived data from the one or more sensors and corresponding archived data depicting one or more historical routes traveled by the elevator car. The operations include determining, via the AI model, a route for the elevator based at least in part on the sensor data, wherein the determined route is the shortest route that satisfies all preset parameters. The operations include transporting the elevator car according to the determined route.

According to a third aspect of the present disclosure, an elevator system is disclosed, including at least one elevator car, a set of sensors configured to acquire sensor data associated with the at least one elevator car, and a controller. The controller is operative to train an AI model with a set of preset parameters, archived data from the one or more sensors and corresponding archived data depicting one or more historical routes traveled by the at least one elevator car. The controller is operative to determine, via the AI model, a route for the elevator car based at least in part on the sensor data, wherein the determined route is the shortest route that satisfies all preset parameters. The controller is operative to transport the elevator car according to the determined route.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram of an embodiment of a smart elevator system, for determining an optimal route for an elevator car using an AI model, in accordance with various embodiments;

FIG. 2 is an example of a schematic block diagram illustrating an apparatus for determining an optimal route for an elevator car using an AI model, in accordance with the disclosure;

FIG. 3 is modified schematic block diagram illustrating an apparatus for determining an optimal route for an elevator car using an AI model, in accordance with the disclosure;

FIG. 4 is a schematic flow chart diagram illustrating a method for determining an optimal route for an elevator car using an AI model according to various embodiments;

FIG. 5 is a modified schematic flow chart diagram illustrating a method for determining an optimal route for an elevator car using an AI model according to various embodiments;

FIG. 6 depicts an illustrative computer network environment that implements an implements an AI model to determine an optimal route for an elevator car according to various embodiments;

FIG. 7 is a block diagram of a device that implements an AI model to determine an optimal route for an elevator car according to various embodiments;

FIG. 8 is a schematic block diagram illustrating a system flowchart illustrating the training and implementation of an AI model to determine an optimal route for an elevator car according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, R, Java, Java Script, Smalltalk, C++, C sharp, Lisp, Clojure, PUP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method of operating a smart elevator system for determining an optimal route for an elevator car using an AI model is disclosed. The method includes receiving, e.g., from one or more sensors, sensor data associated with an elevator car. The method includes training an AI model with a set of preset parameters, archived data from the one or more sensors and corresponding archived data depicting one or more historical routes traveled by the elevator car. The method includes determining, e.g., via the AI model, a route for the elevator car based at least in part on the sensor data, where the determined route is the shortest route that satisfies all preset parameters. The method includes transporting the elevator car according to the determined route.

In some embodiments, in the event of a route planning conflict associated with a sensor malfunction or contradictory sensor information the method may include resolving the route planning conflict by determining, via the AI model, an updated shortest route having a minimal number of stops based on the preset parameters, a position of the elevator car, a quantity of humans (i.e., occupants) detected by the one or more sensors, and one or more locations of the humans detected by the one or more sensors. In some embodiments, the preset parameters include an elevator weight threshold, a volume threshold, an occupant threshold, and an individual occupant temperature threshold.

In some embodiments, upon determining the presence of an incapacitated passenger in the elevator car, the method may include bypassing one or more scheduled stops and proceeding to a predetermined floor in response to the presence of the incapacitated passenger.

In some embodiments, the elevator car is equipped with at least an internal camera and/or a microphone. If an elevator car thus equipped determines, via the one or more sensors, that at least one passenger health threshold is met, the method may include initiating communication, e.g., using the camera or the microphone, between a passenger of the elevator car and an emergency personnel in response to determining that the at least one passenger health threshold is met.

In some embodiments, the method includes determining via one or more cameras a presence and a number of occupants at a landing following a car call, predicting a car requirement based on the presence and the number of occupants at the landing; and dispatching a nearest elevator car that satisfies the predicted car requirement when multiple cars are available. In some embodiments, the method includes monitoring, by a plurality of cameras, an area associated with one or more landings adjacent to an elevator shaft along which the elevator car travels, and determining the route for the elevator car based at least in part on camera data. In some embodiments, training the AI model further comprises training the AI model with the camera data and archived data from the cameras. In some embodiments, the method includes sending updated sensor and/or camera data to the AI model each time the elevator car stops at a landing.

According to another aspect of the disclosure, a control system is disclosed that uses AI to choose an optimal route for an elevator car. The control system includes a processor and non-transitory computer readable storage media storing code. The code is executable by the processor to perform operations that include receiving, from one or more sensors, sensor data associated with an elevator car. The operations include training an AI model with at least: a set of preset parameters, archived data from the one or more sensors and corresponding archived data depicting one or more historical routes traveled by the elevator car. The operations include determining, via the AI model, a route for the elevator based at least in part on the sensor data, wherein the determined route is the shortest route that satisfies all preset parameters. The operations include transporting the elevator car according to the determined route.

In another embodiment, the operations include, in the event of a route planning conflict associated with a sensor malfunction or contradictory sensor information, resolving the route planning conflict comprises determining a shortest route with a minimal number of stops based on a position of the elevator car, a quantity of humans (i.e., occupants) detected by the one or more sensors and one or more location of humans detected by the one or more sensors in keeping with present parameters. In some embodiments, preset parameters comprise at least: a weight threshold, a volume threshold, an occupant threshold, and an individual occupant temperature threshold.

In another embodiment, the operations include determining, via the one or more sensors, that at least one passenger health threshold is met, and initiating communication, using a camera or one or more microphones, between a passenger of the elevator car and an emergency personnel in response to determining that the at least one passenger health threshold is met.

In another embodiment, the operations include determining via one or more cameras a presence and a number of occupants at a landing following a car call, predicting a car requirement based on the presence and the number of occupants at the landing, and dispatching a nearest elevator car that satisfies the predicted car requirement when multiple cars are available. In another embodiment, the operations include training the AI model further comprises training the AI model with camera data and archived data from the cameras. In some embodiments, the operations include sending updated camera data and updated sensor data to the AI model each time the elevator car stops at a landing. In another embodiment, the operations include determining a presence of an incapacitated passenger in the elevator car, and bypassing one or more scheduled stops and proceeding to a predetermined floor in response to the presence of the incapacitated passenger.

According to a third aspect of the disclosure, an elevator system including at least one elevator car, a set of sensors configured to acquire sensor data associated with the at least one elevator car, and a controller is disclosed. The controller is operative to train an AI model with a set of preset parameters, archived data from the one or more sensors and corresponding archived data depicting one or more historical routes traveled by the at least one elevator car. The controller is operative to determine, via the AI model, a route for the elevator car based at least in part on the sensor data, wherein the determined route is the shortest route that satisfies all preset parameters. The controller is operative to transport the elevator car according to the determined route. In some embodiments, the elevator system comprises a multi-shaft elevator configuration having multiple elevator cars. In some embodiments the elevator system comprises a shaft elevator configuration having horizontal, diagonal, curved, or vertical physical configurations.

In some embodiments, in the event of a route planning conflict associated with a sensor malfunction or contradictory sensor information the controller may be operative to resolve the route planning conflict by determining, via the AI model, an updated shortest route having a minimal number of stops based on the preset parameters, a position of a respective elevator car, a quantity of humans (i.e., occupants) detected by the one or more sensors, and one or more locations of the humans detected by the one or more sensors. In some embodiments, the preset parameters include an elevator weight threshold, a volume threshold, an occupant threshold, and an individual occupant temperature threshold.

In some embodiments, upon determining the presence of an incapacitated passenger in a respective elevator car, the controller may be operative to bypass one or more scheduled stops and proceeding to a predetermined floor in response to the presence of the incapacitated passenger.

In some embodiments, at least one elevator car is equipped with at least an internal camera and/or a microphone. If an elevator car thus equipped determines, via the one or more sensors, that at least one passenger health threshold is met, the controller may be operative to initiate communication, e.g., using the camera or the microphone, between a passenger of the elevator car and an emergency personnel in response to determining that the at least one passenger health threshold is met.

In some embodiments, the controller may be operative to determine via one or more cameras a presence and a number of occupants at a landing following a car call, predicting a car requirement based on the presence and the number of occupants at the landing; and dispatching a nearest elevator car that satisfies the predicted car requirement when multiple cars are available. In some embodiments, the controller may be operative to monitor, by a plurality of cameras, an area associated with one or more landings adjacent to an elevator shaft along which the at least one elevator car travels, and to determine the route for the elevator car based at least in part on camera data. In some embodiments, the controller may be operative to train the AI model with the camera data and archived data from the cameras. In some embodiments, the controller may be operative to send updated sensor and/or camera data to the AI model each time the elevator car stops at a landing.

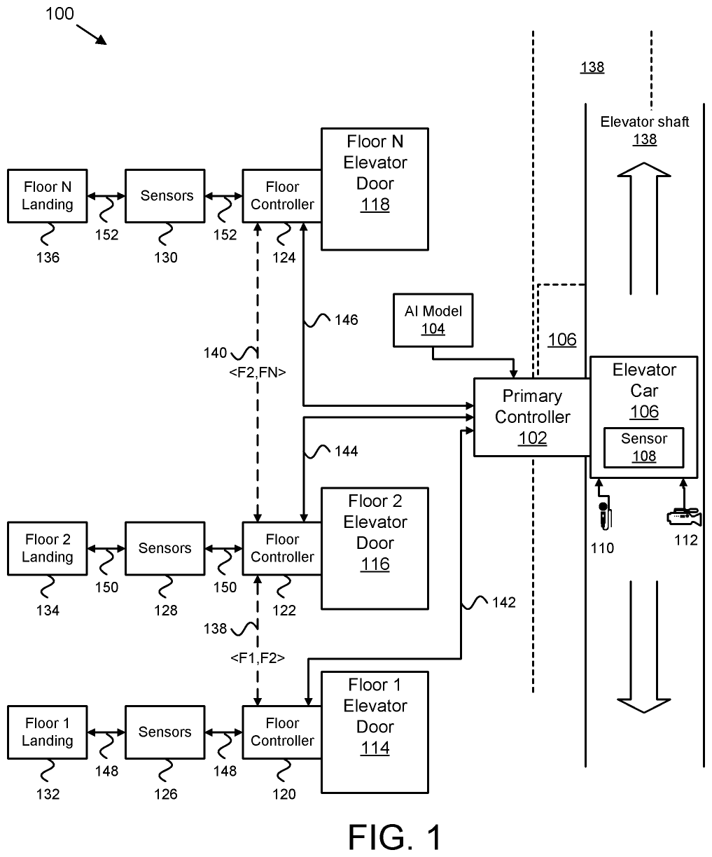

FIG. 1 depicts an embodiment of an intelligent transport system (“ITS”) 100, for determining an optimal route for an elevator car, e.g., using an AI model, in accordance with various embodiments. The ITS 100 includes a primary controller 102 coupled with at least one elevator car 106, the elevator car 106 being equipped with a set of one or more internal sensors 108. In some embodiments, the ITS 100 also includes a plurality of floor controllers coupled with the primary controller 102. In the depicted embodiment the ITS 100 includes a first floor controller 120 associated with a first floor (denoted as “Floor 1”), a second floor controller 122 associated with a second floor (denoted as “Floor 2”), and an Nth floor controller 124 associated with an Nth floor (denoted as “Floor N”).

Each floor controller 120, 122, 124 may be coupled with a set of landing sensors for gathering information related to a respective landing and/or elevator doors. In the depicted embodiment the ITS 100 includes a first set of landing sensors 126 associated with the first floor, a second set of landing sensors 128 associated with the second floor, and an Nth set of landing sensors 130 associated with the Nth floor, where floor N is the last floor in the structure.

The primary controller 102 receives traffic information from respective floor controllers 120, 122, 124 via the data links 142, 144, 146. In various embodiments, each respective floor controllers 120, 122, 124 may act as a receiving processor at each elevator door. In various embodiments, the primary controller 102 is a scheduler which uses an AI model 104 to determine an optimal route for elevator car 106. The AI model 104 is a computing model used to determine the optimal router and may include a machine learning (ML) model, a Deep Learning model, a computational model, a simulator model, a neural network model, cognitive model, or any combination thereof.

In some embodiments, at each floor along the path traversed by the elevator, the one or more landing sensors 126, 128, 130 may scan corresponding landings and elevator doors, namely the first set of landing sensors 126 may monitor the Floor 1 landing 132 and the Floor 1 Elevator Door 114, the second set of landing sensors 128 may monitor the Floor 2 landing 134 and the Floor 2 Elevator Door 116, the Nth set of landing sensors 130 may monitor the Floor N landing 136 and the Floor N Elevator Door 118, etc. The one or more landing sensors 126, 128, 130 may then feed data to the corresponding floor controllers 120, 122, 124. The paths this data takes between the landings 132, 134, 136, the landing sensors 126, 128, 130 and the floor controllers 120, 122, 124 are shown at data links 148, 150, 152. In some embodiments, data from the landing sensors 126, 128, 130 may be transmitted between floor controllers 120, 122, 124. The sensor data transfer 138 between the first floor controller 120 and the second floor controller 122 is represented as <F1, F2>. This representation continues in like manner, ending with the representation between the controller on the penultimate floor and the last floor as <FX,FN>, wherein X represents N−1. In the depicted embodiment, the sensor data transfer 140 between the second floor controller 122 and the Nth floor controller 124 is represented as <F2, FN>; however, where there are additional floors between the second and Nth floors, additional sensor data transfers may occur between floor controllers on adjacent floors.

The primary controller 102 may be one of any number of computing devices suitable for processing inputs from sensors and commands from users to control the movement of the elevator car(s) 106. For example, the primary controller 102 may receive data from the internal sensors, 108, the landing sensors 126, 128, 130, and external sources. In various embodiments, the primary controller 102 may be capable of running an AI model 104, which is described in more detail below. In other embodiments, the primary controller 102 may be communicatively coupled with an AI engine running the AI model 104. Based on the sensor data and user commands, the primary controller 102 determines, via the AI model 104, a route for the elevator car, as described below in further detail.

In some embodiments, the floor controllers 120, 122, 124 act as receiving processors on each floor. The floor controllers 120, 122, 124 may be implemented using any of a number of computing devices suitable for receiving, sending, and processing sensor data. The primary controller 102, the internal sensors 108, the landing sensors 126, 128, 130, the floor controllers 120, 122, 124 and the data links 142, 144, 146, 148, 150, and 152 constitute a local network which may have wired or wireless connections, as discussed further below.

The local network may include a wireless connection that may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM” ®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

The internal sensors 108 include one or more measuring devices suitable for assessing the environment within the elevator car 106, e.g., as it relates to factors relevant to safe and efficient travel. As used herein, the environment within the elevator car 106 refers to the physical conditions (e.g., temperature, climate control, noise level, ventilation, air quality), the occupancy of the elevator car 106, the available capacity of the elevator car 106, and the like.

Various internal sensors 108 such as but not limited to proximity sensors, motion sensors, scales, temperature sensors, moisture sensors, infrared sensors, and volume sensors may be used to assess the condition of the elevator car 106 in order to compare it against preset thresholds for categories including the structural integrity of the elevator car 106 and the health of the passengers. As used herein, the condition of the elevator car 106 refers to the environment of the elevator car 106 as well as the position of the elevator car 106, the weight of the elevator car 106, the demand for the elevator car 106, and the like.

In addition to internal sensors 108 located at or within elevator car 106, additional sensing devices such as microphones 110 and cameras 112 may be found in or near elevator car 106 in some embodiments. When present, the microphones 110 and/or cameras 112 may be used to determine occupancy of an elevator car 106 and/or determine whether one or more preset parameters are satisfied. In certain embodiments, the one or more microphones 110 may include digital microphones, such as multi-directional microphones, analog microphones, or other sensors suitable for capturing sound and/or other audible data. Cameras 112 may also be utilized, such as mini dome cameras, pinhole cameras, corner cameras, or other image sensors suitable for video, picture, and/or other visual data. Note however that certain jurisdictions may forbid the use of microphones 110 and/or cameras 112 in the elevator car 106. In such situations, the primary controller 102 may use different internal sensors 108 to determine occupancy of an elevator car 106 and/or determine whether one or more preset parameters are satisfied.

At each landing 132, 134, 136 along the elevator shaft 138, the landing sensors 126, 128, 130 may be at least substantially similar devices operative to assess the landing 132, 134, 136 to determine at least the presence of candidate passengers and assess the elevator doors 114, 116, 118 at least to determine whether the doors of the elevator door on the relevant floor are in motion. For example, an exemplary set of landing sensors may include weight/pressure sensors, motion sensors, cameras, microphones, proximity sensors, temperature sensors, or the like. In one embodiment, the landing sensors 126, 128, 130 are operative to detect the presence of candidate passengers (i.e., persons wanting to enter an elevator car 106). In another embodiment, the landing sensors 126, 128, 130 are operative to detect an amount of candidate passengers.

In further embodiments, the landing sensors 126, 128, 130 are operative to predict (e.g., via the AI model 104) a volume and/or weight requirement of the candidate passengers (including luggage, boxes, furniture, shopping bags, work material, medical equipment, or other personal and/or bulky items near the candidate passengers) in response to a landing call. In such a case, sensor data from the internal sensors 108 of one or more elevator car(s) may be used to determine a nearest elevator car 106 that has capacity for the candidate passengers (and their items).

Note in the above scenario the most proximate elevator car 106 may not be able to accommodate the candidate passengers (and their items). Therefore, where the ITS 100 is implemented as a multi-car elevator system, the primary controller 102 would select another elevator car 106 having capacity for expected weight and/or volume requirements of the candidate passengers. Moreover, where the ITS 100 is implemented as a single-car elevator system, the primary controller 102 would not stop at the landing if the expected weight and/or volume requirements of the candidate passengers would exceed the capacity of elevator car 106.

As used herein, the term “landing call” refers to a request made from outside the elevator, e.g., at a floor landing. In contrast, a “car call,” as used herein, refers to a request made by a passenger inside the elevator car to stop at a particular floor. Accordingly, when passengers press the buttons inside the elevator car 106 to select their desired floor, they are making a car call. The ITS 100 then processes these car calls along with any landing calls to optimize the movement of the elevator cars 106 and efficiently transport passengers to their destinations.

According to one aspect of the disclosure, the ITS 100 monitors the number of passengers in an elevator car 106 (including a weight parameter and/or an occupied volume parameter) to determine if the elevator car 106 is at capacity. When at capacity, the ITS 100 will only stop at floors for which there is a corresponding car call and will ignore landing calls until there is capacity to accommodate the candidate passengers waiting at a landing. Where a landing call is made at a floor that also corresponds to a pending car call for an elevator car 106 that is at capacity, the primary controller 102 may trigger an announcement or other notice that the elevator call is full and (optionally) that another elevator car is on its way to receive the candidate passengers waiting at a landing.

In determining an optimal route for the elevator car 106 the primary controller 102 employs an algorithm that considers current sensor data in light of at least preset parameters to predict a desired route that avoids an unfavorable situation (e.g., avoiding danger, avoiding reaching an operation limitation (e.g., weight, volume) of the elevator car 106) or to leads to a favorable situation (e.g., reduced travel time). For example, an elevator passenger may mistakenly press the wrong floor button in the elevator car 106, or may change their mind about the destination floor. Where two car calls are pending for an elevator car 106 that containing only one passenger (or more generally, where there are more car calls than passengers), the primary controller 102 may cancel the pending car calls and prompt the passenger(s) to re-select the desired floor. Similarly, a car call associated with an unoccupied elevator car 106 may be ignored by the ITS 100.

In some embodiments, the primary controller 102 may be configured to detect multiple button presses by the same passenger. For example, cameras, proximity sensors, motion sensors, timers, etc. may be used to determine that the same person has made multiple car calls within a short amount of time. In one case, the same passenger may be making car calls on behalf of other passengers, for example, an elevator operator or a passenger already near the call buttons may make the multiple car calls within a short amount of time. However, in another case a passenger may maliciously press several buttons in an attempt to delay the other passengers or cause mischief.

Therefore, the AI model 104 may be used to predict whether the multiple car calls are benevolent or malicious. In the case of benevolent car calls, the primary controller 102/or AI model 104 may consider all the pending car calls when routing the elevator car 106. On the other hand, in the case of malicious car calls, the primary controller 102 and/or AI model 104 may ignore (or cancel) the malicious car calls in order to reduce travel time and efficiently route the elevator car 106. Factors the AI model 104 may consider when distinguishing between benevolent and malicious car calls include the relative timing of the button presses (e.g., smaller delay between button presses may indicate malicious intent), the order in which the buttons are pressed (e.g., adjacent buttons being presses in sequence may indicate malicious intent or a mistake), estimated age (e.g., determined by size, weight, facial features, etc.) of the person pressing the buttons (e.g., a child pressing multiple call buttons may indicate malicious intent or a mistake), and the like.

As another example, certain internal sensors 108 (such as an altimeter, encoder, limit switch, Hall effect sensor, ultrasonic sensor, etc.) may be used to assess the height of the elevator car in order to compare it against the known heights of the respective floors, e.g., entered as preset parameters. Here, height/altitude datapoints could indicate that the elevator car was at floor 3 and headed up. Moreover, other internal sensors 108 (such as heat sensors, flame sensors, gas detectors, and/or smoke detectors) may assess that a fire is likely present higher up in the structure. In light of the fact that the ladders of many firefighting departments fail to extend beyond the height of the seventh or eighth floor (e.g., stored as a preset parameter), the primary controller 102 would immediately stop the ascent of the elevator car 106 when passengers are present inside the elevator car 106, i.e., based on the assessment of danger (i.e., fire) and the preset parameter indicating a limitation of emergency services to rescue passengers above a specific floor.

According to one aspect of the present disclosure, the internal sensors 108 may include one or more weight sensors coupled with the floor of the elevator car 106. Here, the weight sensor(s) may be used to determine whether the maximum capacity of the elevator car is reached (or whether a threshold weight is reached). Accordingly, the ITS 100 may use the weight information to skip certain floors and/or ignore landing calls as described above.

According to one aspect of the present disclosure, the camera 112 may be input to a camera AI engine/model to determine if space is available inside the ITS. Similarly, camera data for a floor landing 132, 134, 136 may be camera AI engine/model to determine if there is a candidate passenger awaiting the elevator car 106 and/or whether the elevator car 106 can accommodate the candidate passenger(s), and halt only if there is enough space available, as described above. Where social distancing (i.e., a minimum space between people to mitigate the spread of contagious diseases) is implemented, the preset parameters may include a volume threshold (i.e., spacing threshold) for social distancing and the AI model 104 may respond to landing calls based of the volume/spacing threshold (i.e., to ensure adequate space between passengers) even when there is excess weight capacity.

According to a further aspect of the present disclosure, the ITS 100 may use the camera data and camera AI engine/model to determine if there is a person lying on floor of the elevator car 106, in a supported position within the elevator car 106, or in another pose indicative of a medical emergency. In such embodiments, the primary controller 102 may be operative to alert the medical support staff and make a stop at predesignated floor (i.e., including bypassing one or more stops corresponding to car calls or landing calls). Where permitted, the internal sensors 108 may include an audio sensor (e.g., microphone 110) to assist in ascertaining the medical emergency.

According to one aspect of the present disclosure, the internal sensors 108 may include one or more temperature sensors operative to monitor the temperature of the passengers of the elevator car 106. For example, a set of infrared sensors or a thermal camera may be used to monitor the temperature of the passengers. The temperature data then may be input to the AI model 104 to determine whether a passenger inside the elevator car 106 is feeling uncomfortable. Where a distressed/uncomfortable passenger is detected, the ITS 100 may pick the nearest stop to let the affected passenger off. Moreover, in case of emergency, the ITS may override the previous route (i.e., bypassing one or more stops corresponding to car calls or landing calls) and transport the elevator car 106 to the ground floor or to another predetermined floor where emergency assistance is available.

According to one aspect of the present disclosure, the internal sensors 108 may include one or more motion sensors, whereby the ITS 100 may use the data from the motion sensor(s) to determine if space is available inside the elevator car 106. For example, the AI model 104 may be trained with historical movement data indicative of a crowded elevator car 106 (i.e., where there is little space available and passengers are tightly packed), with historical movement data indicative of a spacious elevator car 106 (i.e., where there is at least one passenger and there is enough room for comfortable movement), and optionally trained with historical data indicative of one or more intermediate levels of capacity. Thereafter, the AI model 104 may predict a current capacity of the elevator car 106 based at least in part on data from the motion sensor(s).

According to one aspect of the present disclosure, the internal sensors 108 may include one or more moisture/humidity sensors, whereby the ITS 100 may use data from the moisture/humidity sensor(s) to determine the presence of passengers inside the elevator car 106 (e.g., due to increased humidity/moisture from transpiration, respiration, perspiration, etc.). Accordingly, the AI model 104 may be trained with data from the moisture/humidity sensor(s) in order to predict the presence of a passenger. Moreover, the data from the moisture/humidity sensor(s) may be supplemented with data from one or more weight sensors for a more accurate detection of passenger presence.

According to one aspect of the present disclosure, the internal sensors 108 may include one or more proximity sensors, wherein by the ITS 100 may use data from the proximity sensor(s) to determine if space is available inside the elevator car 106. For example, the AI model 104 may be trained with historical proximity data indicative of a crowded elevator car 106 (e.g., where the data indicates small distances between the passengers and a wall of the elevator car 106), with historical proximity data indicative of an spacious elevator car 106 (i.e., where the data indicate long distances between the passengers and the walls of the elevator car 106), and optionally trained with historical data indicative of one or more intermediate levels of capacity. Thereafter, the AI model 104 may predict a current capacity of the elevator car 106 based at least in part on data from the proximity sensor(s). Additionally, a proximity sensor located near the elevator doors may be used to determine a number of passengers (e.g., by tracking entrances and exits).

The elevator car 106 is operative to traverse an elevator shaft 138 in accordance with the route determined by the primary controller. In some embodiments, the ITS 100 may include multiple shafts and/or multiple elevator cars 106. While FIG. 1 depicts an essentially vertical elevator shaft 138, the ITS 100 is not restricted to a system comprising a vertical shaft. In other embodiments, the ITS 100 may comprise a vertical shaft, an angled or diagonal shaft, and/or a horizontal “shaft”. In some embodiments, the ITS 100 may comprise means for transporting one or more elevator cars in a vertical direction, a horizontal direction, an angled direction, a diagonal direction, or some combination thereof.

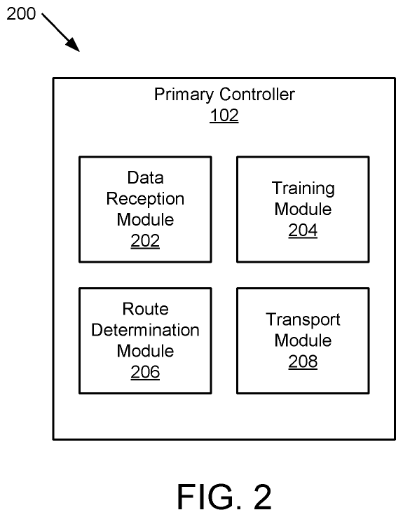

FIG. 2 is an example of a schematic block diagram illustrating an apparatus for determining an optimal route for an elevator car using an AI model, in accordance with the disclosure. The apparatus 200 corresponds to an elevator control system and may include one embodiment of the primary controller 102. The primary controller 102 includes a data reception module 202, a training module 204, a route determination module 206, and a transport module 208. In some embodiments, the apparatus 200 is implemented using executable code stored on computer readable storage media. In other embodiments, all or a portion of the apparatus 200 is implemented using a programmable hardware device and/or hardware circuits.

In some embodiments, the primary controller 102 includes a data reception module 202 configured to receive from one or more sensors, sensor data associated with an elevator 106. For example, the primary controller 102 may receive sensor data from the set of internal sensors 108 and/or from the landing sensors 126, 128, 130. The data reception module 202 may include transceiver, a modem, or other like hardware capable of receiving data signals from throughout the elevator system. In some embodiments, the data reception module 202 is configured to receive sensor data from floor controllers 120, 122, 124. In certain embodiments, the floor controllers 120, 122, 124 receive information from the landing sensors 126, 128, 130 monitoring the floor landings 132, 134, 136 and/or the elevator door 114, 116, 118 on their respective floors. Alternatively, sensor data may be transmitted from the landing sensors 126, 128, 130 directly to the data reception module 202. In some embodiments, the received sensor data may be archived in a database within the primary controller 102 or at another storage location.

In some embodiments, the primary controller 102 includes a training module 204 operative to train an AI model with a set of preset parameters, archived data from the one or more sensors and corresponding archived data depicting one or more historical routes traveled by the elevator. Additionally, the training module 204 may train the AI model with preset parameters during an offline training period. The offline training period may occur for example prior to first operation of the system, at a set time daily, or during scheduled maintenance. Offline training of the AI model may include batch processing of archived sensor and/or route data. In some embodiments, the training module 204 may perform online training of the AI model whereby incremental updates are made to the data sets during the operation of the elevator system. For example, the training module 204 may update the AI model with sensor and/or route data at each stop.

The preset parameters include contextual information required for planning a safe and efficient route for the elevator car 106 to travel. The preset parameters may include, for example, threshold values that trigger mitigation in various emergency circumstances, such as, but not limited to a threshold carbon monoxide value that may be detected before calling emergency services. In some embodiments, the preset parameters include at least a weight threshold, a volume/space threshold, an occupant threshold, and an individual occupant temperature threshold, and the like.

In some embodiments, the primary controller 102 includes a route determination module 206 configured to determine, via the AI model 104, a route for the elevator 106 based at least in part on the sensor data, wherein the determined route is the shortest route that satisfies all preset parameters. The route determination module 206 may be comprised of hardware including at least one processor. The route determination module 206 employs a route planning algorithm that considers the current system environment (e.g., temperature, climate control, noise level, ventilation, air quality, the position of the elevator car 106, the weight of the elevator car 106, the demand for the elevator car 106, etc.) as depicted by current sensor data and preset parameters with which the AI model 104 was trained during a training period.

For example, a current weight of an elevator car may be compared against the weight threshold and the route determination module 206 may generate an elevator car route that satisfies the weight threshold (including ignoring landing calls when the weight threshold is reached). The weight threshold may be based on a maximum weight requirement and may include a safety margin.

As another example, a current occupancy of an elevator car may be compared against the occupancy threshold and the route determination module 206 may generate an elevator car route that satisfies the occupancy threshold (including ignoring landing calls when the occupancy threshold is reached or would be exceeded by receiving the number of candidate passengers waiting at a landing).

In yet another example, a current occupied volume (or available space) of an elevator car may be compared against the volume threshold (or space threshold) and the route determination module 206 may generate an elevator car route that satisfies the volume threshold and/or space threshold (including ignoring landing calls when the weight threshold is reached). In certain embodiments, volume threshold (or space threshold) may be based on a minimum recommended distance between elevator car passengers.

In a further example, a current temperature of each passenger in an elevator car may be compared against the individual occupant temperature threshold and the route determination module 206 may bypass a previously generated elevator car route if an individual passenger's temperature meets (or exceeds) the individual occupant temperature threshold.

In some embodiments, the primary controller 102 includes a transport module 208 configured to transport the elevator car according to the determined route. While the elevator car 106 follows the prescribed route it may be subject to recall and rerouting by the primary controller 102 based on newly received information. For example, a detected emergency condition may override a previously generated route and/or impose additional routing limitations as described above.

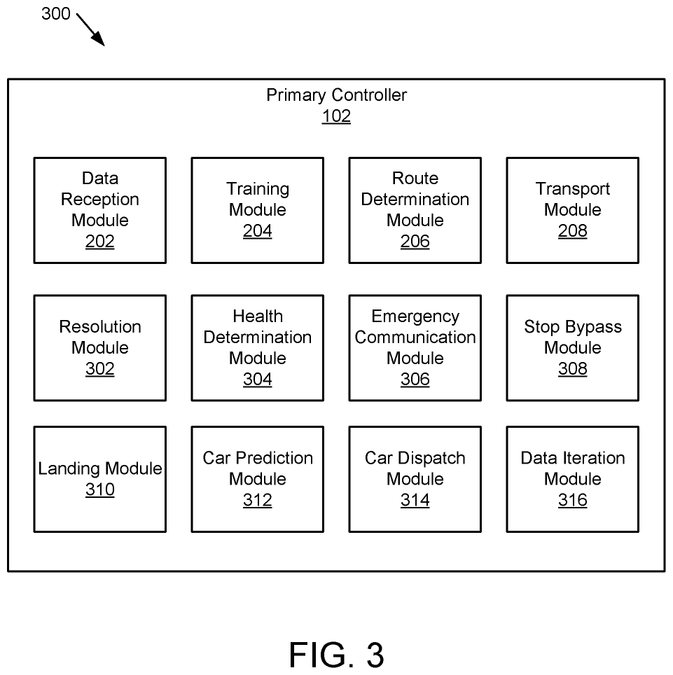

FIG. 3 is a modified schematic block diagram illustrating an apparatus for determining an optimal route for an elevator car using an AI model, in accordance with the disclosure. The apparatus 300 corresponds to an elevator control system and includes another primary controller 102 with data reception module 202, a training module 204, a route determination module 206, and a transport module 208 which are substantially similar to those described above in relation to the apparatus 200 of FIG. 2. The apparatus 300, in various embodiments, additionally includes one or more of a resolution module 302, a health determination module 304, an emergency communication module 306, a stop bypass module 308, a landing module 310, a car prediction module 312, a car dispatch module 314, and a data iteration module 316, which are described below. In some embodiments, the apparatus 300 is implemented using executable code stored on computer readable storage media. In other embodiments, all or a portion of the apparatus 300 is implemented using a programmable hardware device and/or hardware circuits.

In some embodiments, the apparatus 300 includes a resolution module 302 configured to resolve a route planning conflict associated with a sensor malfunction or contradictory sensor information by determining, via the AI model, an updated shortest route having a minimal number of stops based on the preset parameters, a position of the elevator car, a quantity of humans (i.e., passengers) detected by the one or more sensors, and one or more location of humans detected by the one or more sensor in keeping with the preset parameters.

If for example, the data from a weight sensor does not change by an expected amount when passengers embark or disembark from the elevator car, then the resolution module 302 may determine that the weight sensor is likely malfunctioning and cause the AI model to deprioritize (or disregard) data from the weight sensor.

As another example, if the data from a proximity sensor indicates that the elevator car is crowded, but data from a motion sensor indicates that the elevator car is not crowded, then the resolution module 302 may cause the AI model to deprioritize (or disregard) data from the proximity sensor and the motion sensor, at least with regard to an prediction of the amount of space available within the elevator car. Alternatively, the resolution module 302 may cause the AI model to give greater weight to data from other sensors when predicting whether the elevator car is crowded.

Upon addressing the sensor malfunctions and/or contradictory sensor information, the AI model may determine that certain threshold corresponding to preset parameter are met (or not met). Accordingly, such adjustments may cause the AI model to determine an updated shortest route upon addressing the sensor malfunctions and/or contradictory sensor information. While depicted as a separate module, in certain embodiments the resolution module 302 may be a component of the data reception module 202 and/or the route determination module 206.

In some embodiments, the apparatus 300 includes a health determination module 304 configured to determine, via the one or more sensors, that at least one passenger health threshold is met. The passenger health threshold may be a temperature threshold, a respiration threshold, a motion threshold, or similar threshold indicative of a health-related emergency. As discussed above, a temperature sensor may be used to assess the individual temperature of the passengers and thereby determine whether a passenger is ill or suffering a health-related emergency. In certain embodiments, the heath determination module 304 may be configured to determine the presence of an incapacitated passenger in the elevator car, e.g., based at least in part on the passenger health threshold being satisfied. While depicted as a separate module, in certain embodiments the health determination module 304 may be a component of the data reception module 202.

In related embodiments the apparatus 300 may include an emergency communication module 306 configured to, upon a determination that a passenger threshold has been met initiating communication, using the camera or the microphone, between a passenger of the elevator car and an emergency personnel. For example, if a motion sensor indicates that a passenger has been horizontal on the floor of the elevator car for a set number of minutes (thereby satisfying a passenger health threshold), the passenger will be presumed to be unconscious. In response, emergency personnel will be prompted to assess the passenger using the microphone 110 and/or the camera 112 to confirm that the passenger is experiencing a health emergency.

In related embodiments, the apparatus 300 includes a stop bypass module 308 configured to bypass one or more scheduled stops and proceed to a predetermined floor in response to the presence of the incapacitated passenger. In one embodiment, the predetermined floor is the ground floor. In another embodiment, the predetermined floor corresponds to the location of medical staff. The predetermined floor may be provided to the AI model as part of the preset parameters. The above embodiments are aimed at protecting the health of passengers who are suddenly disabled, such as passengers who are victims of violence or who have suffered accidents. While depicted as a separate module, in certain embodiments the stop bypass module 308 may be a component of the route determination module 206.

In some embodiments, the apparatus 300 includes a landing module 310 configured to monitor, e.g., by one or more cameras or other sensors, an area associated with one or more landings adjacent to an elevator shaft along which the elevator car travels. Accordingly, the landing module 310 may determine a presence and a number of potential passengers at a landing, e.g., following a landing call. While depicted as a separate module, in certain embodiments the landing module 310 may be a component of the data reception module 202 and/or the route determination module 206.

In related embodiments, the apparatus 300 may include a car prediction module 312 configured to predict a car requirement based on the presence and the number of potential passengers at a respective landing. For example, the car prediction module 312 may predict a weight and/or space requirement of the potential passenger(s) at the landing. While depicted as a separate module, in certain embodiments the car prediction module 312 may be a component of the route determination module 206.

In related embodiments, the apparatus 300 may include a car dispatch module 314 configured to dispatch a nearest elevator car that satisfies the predicted car requirement when multiple cars are available. The above embodiments are aimed at, for example, preventing sending an elevator car 106 unnecessarily in the event that potential passengers call for an elevator car 106 and then leave while the elevator car 106 is in route. Similarly, the car dispatch module 314 may prevent sending the elevator car 106 to a floor when the number of pending car calls exceeds the number of passengers in the elevator car 106. While depicted as a separate module, in certain embodiments the car dispatch module 314 may be a component of the route determination module 206.

In some embodiments, the apparatus 300 includes a data iteration module 316 configured to send updated camera and/or sensor data to the AI model 104, e.g., each time the elevator car stops at a landing. Such data may be archived and later used for continued training of the AI model 104. The above embodiments ensure that that primary controller is continually kept aware of the state of the system, allowing for informed planning of the route taken by the elevator car 106. While depicted as a separate module, in certain embodiments the data iteration module 316 may be a component of the data reception module 202 and/or the training module 204.

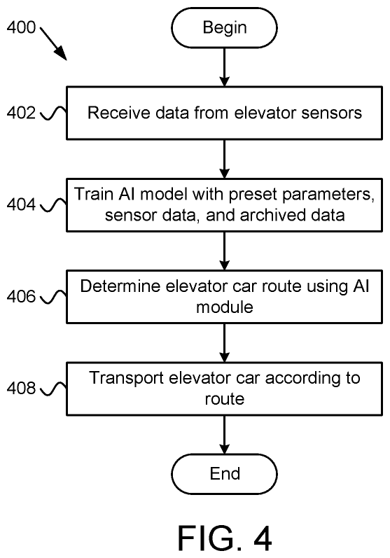

FIG. 4 is a schematic flow chart diagram illustrating a method for determining an optimal route for an elevator car using an AI model according to various embodiments of the disclosure. In various embodiments, the method 400 is performed by an ITS control device, such as the primary controller 102, the apparatus 200, and/or the apparatus 300, as described above. In some embodiments, the method 400 is performed by a processor, such as a microcontroller, a microprocessor, a central processing unit (“CPU”), a graphics processing unit (“GPU”), an auxiliary processing unit (“APU”), a FPGA, or the like.

The method 400 begins and receives 402 data from elevator sensors. The elevator sensors may include, but are not limited to, one or more of proximity sensors, motion sensors, scales, temperature sensors, moisture sensors, infrared sensors, volume sensors, or any combination thereof. In some embodiments, receiving 402 the data includes receiving sensor data from one or more internal sensors 108 at a primary controller 102.

The method 400 includes training 404 a computing model, such as the AI model 104, with preset parameters and current sensor data. In various embodiments, training 404 the computing model may include training an AI model with archived data from the one or more sensors and corresponding archived data depicting a historical route traveled by the elevator car. In certain embodiments, training 404 the computing model may include training the AI model with camera data and/or archived data from one or more cameras.

The method 400 includes determining 406 a route for an elevator car (e.g., the elevator car 106) using the computing model. In various embodiments, determining 406 the route is based at least in part on the sensor data, such that the determined route is the shortest route that satisfies all preset parameters. The method 400 includes transporting 408 the elevator car in keeping with the planned route. The method 400 ends.

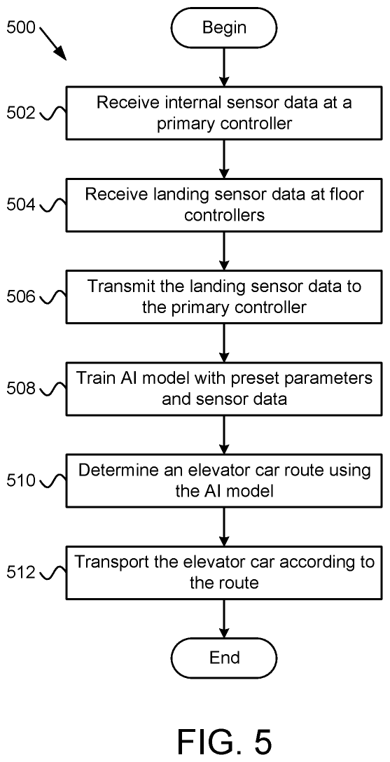

FIG. 5 is a modified schematic flow chart diagram illustrating a method for determining an optimal route for an elevator car using an AI model according to various embodiments of the disclosure. In various embodiments, the method 500 is performed by an ITS control device, such as the primary controller 102, the apparatus 200, and/or the apparatus 300, as described above. In some embodiments, the method 500 is performed by a processor, such as a microcontroller, a microprocessor, a CPU, a GPU, an APU, a FPGA, or the like.

The method 500 begins and receives 502 data from internal sensors at a primary controller. The internal sensors may include, but are not limited to, one or more of proximity sensors, motion sensors, scales, temperature sensors, moisture sensors, infrared sensors, volume sensors, cameras, microphones, or any combination thereof. In some embodiments, receiving 502 the data includes receiving sensor data from one or more internal sensors at a primary controller.

The method 500 includes receiving 504 data from one or more landing sensors at one or more corresponding floor controllers. The landing sensors may include, but are not limited to, one or more of proximity sensors, motion sensors, scales, temperature sensors, infrared sensors, cameras, microphones, or any combination thereof.

The method 500 includes transmitting 506 the landing sensor data from one or more of the floor controllers to the primary controller. In some embodiments, transmitting 506 the landing sensor data includes receiving the sensor data at the primary controller, via one or more datalinks.

The method 500 includes training 508 an AI model with preset parameters and current sensor data. In some embodiments, the primary controller trains 508 the AI model. In certain embodiments, training 508 the AI model includes training the AI model with archived data from the one or more sensors and corresponding archived data depicting a historical route traveled by the elevator car. In certain embodiments, training 508 the AI model may include training the AI model with camera data and/or archived data from one or more cameras.

The method includes determining 510 a route for the elevator car to travel via a route planning algorithm that considers at least current sensor data and preset parameters. In various embodiments, determining 510 the route is based at least in part on the sensor data, such that the determined route is the shortest route that satisfies all preset parameters. The method 500 includes transporting 512 the elevator car according to the planned route. The method 500 ends.

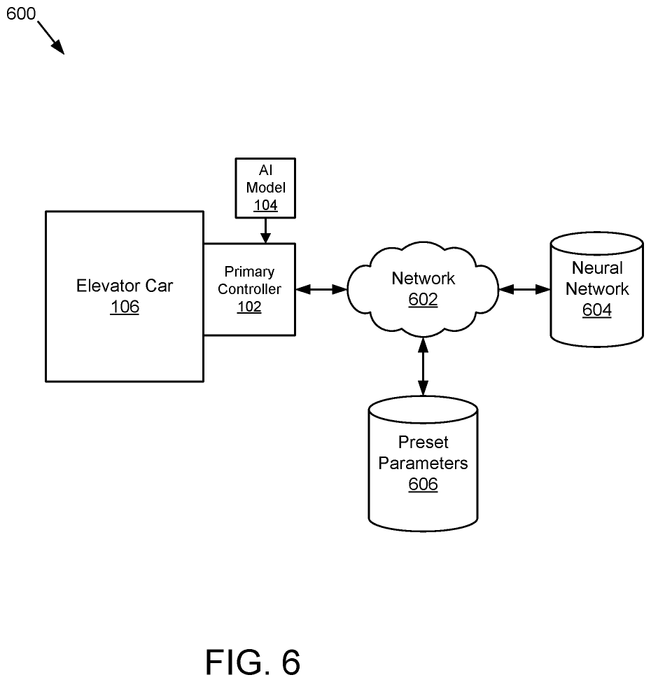

FIG. 6 depicts an illustrative computer network environment 600 that implements an AI model to determine an optimal route for an elevator car according to various embodiments. The environment 600 includes the primary controller 102, a data network 602, a neural network 604, stored preset parameters 606. The primary controller 102 is a scheduler which uses an AI model 104 to determine an optimal route for elevator car 106. The primary controller 102 may be computer system including one or more computer components (e.g., servers, blades, etc.) and/or other computer components (e.g., processors, memories, and communication interfaces) operative to train, host, or otherwise maintain an artificial intelligence engine. The artificial intelligence engine may source data from at least a database storing preset parameters 606 and a relevant neural network 604 to train an AI model operative to find an optimal travel route for an elevator car 106. The neural networks include datasets of predictive behavior from substantially similar smart elevator systems. The neural networks may include node layers with an input layer, one or more hidden layers, and an output layer. In some embodiments, the hidden layers are deep learning and are two or more layers deep.

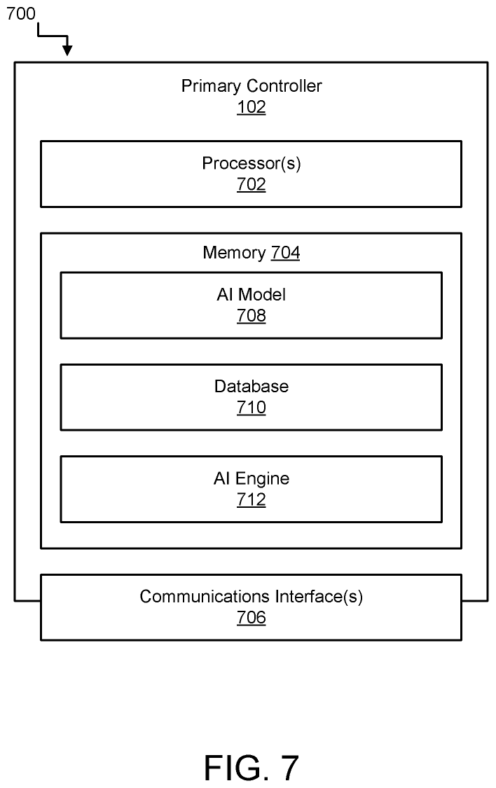

FIG. 7 is a block diagram of an elevator control device 700 that implements an AI model to determine an optimal route for an elevator car according to various embodiments. The elevator control device 700 includes one embodiment of the primary controller 102. The primary controller 102 includes one or more processors 702, at least one memory 704, and one or more communication interfaces 706. A computer bus, or plurality of buses, may interconnect the processor(s) 702, memory device(s) 704, the communication interface(s) 706, and other devices to enable data and/or instructions to pass therebetween.

In some embodiments, the communications interface 706 may comprise a network interface that supports communication between the primary controller 102 and one or more data networks 602 to perform one or more functions. In some embodiments, the communications interface 706 may comprise a network interface that supports communication between the primary controller 102 and one or more sensors. In some embodiments, the communications interface 706 may comprise a network interface that supports communication between the primary controller 102 and one or more floor controllers (e.g., floor controllers 120, 122, 124).

The processor(s) 702 may be operably connected to the memory 704. The memory 704 may include one or more non-volatile storage devices such as hard drives, solid state drives, CD-ROM drives, DVD-ROM drives, tape drives, or the like. The memory 704 may also include non-volatile memory such as a read-only memory (e.g., ROM, EPROM, EEPROM, and/or Flash ROM) or volatile memory such as a random access memory (e.g., RAM or operational memory).

Additionally, the memory 704 may have, host, store, and/or include an AI model 708, a database 710, and an AI engine 712. The primary controller 102 may have instructions that direct or cause the automated training, maintenance, and implementation of the AI model 708 and AI engine 712 for route planning.

The AI model 708 is the mathematical representation or structure that the primary controller 102 uses to perform tasks (i.e., car routing) or make predictions based on sensor input data (e.g., from the internal sensors 108 and/or the landing sensors 126, 128, 130). The sensor input data, the route data, preset parameters, current values for car parameters, and other data as described above may be stored within the database 710. The AI engine 712 comprises the software and/or hardware that integrates and executes the AI model 708 to perform tasks, process data, and generate outputs, e.g., as described herein.

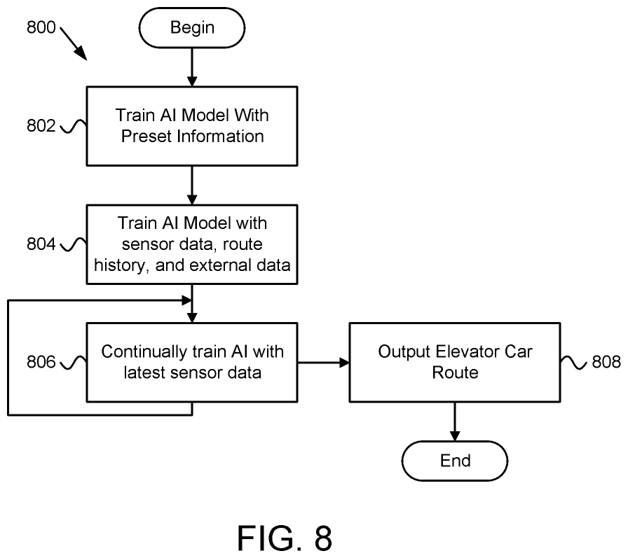

FIG. 8 is a schematic block diagram illustrating a method 800 for the training and implementation of an AI model to determine an optimal route for an elevator car according to embodiments of the disclosure. In various embodiments, the method 500 is performed by an ITS control device, such as the primary controller 102, the apparatus 200, and/or the apparatus 300, as described above. In some embodiments, the method 500 is performed by a processor, such as a microcontroller, a microprocessor, a CPU, a GPU, an APU, a FPGA, or the like.

The method 800 begins and trains 802 an AI model (such as the AI model 104 and/or AI model 708) with preset parameters during a training period or at a time before system operations begin in order to provide context for route planning. The method 800 includes training 804 the AI model with current sensor information, passenger traffic history information and contextual information from outside of the system. The method 800 includes continually training 806 the AI model with sensor data updated and sent to the primary controller 102, e.g., each time an elevator car (such as the elevator car 106) stops at a different landing. The method 800 includes outputting 808 an optimal route for the elevator car.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of an elevator system comprising:
receiving, from one or more sensors, sensor data associated with an elevator car;
training an artificial intelligence (“AI”) model with a set of preset parameters, archived data from the one or more sensors and corresponding archived data depicting a historical route traveled by the elevator car;
determining, via the AI model, a route for the elevator car based at least in part on the sensor data, wherein the determined route is a shortest route that satisfies the set of preset parameters; and
transporting the elevator car according to the determined route.

2. The method of claim 1, further comprising:
resolving a route planning conflict associated with a sensor malfunction or contradictory sensor information,
wherein resolving the route planning conflict comprises determining, via the AI model, an updated shortest route having a minimal number of stops based on the set of preset parameters, a position of the elevator car, a quantity of humans detected by the one or more sensors, and one or more locations of the humans detected by the one or more sensors.

3. The method of claim 1, further comprising:
determining a presence of an incapacitated passenger in the elevator car; and
bypassing one or more scheduled stops and proceeding to a predetermined floor in response to the presence of the incapacitated passenger.

4. The method of claim 1, wherein the set of preset parameters comprises at least: a weight threshold, a volume threshold, an occupant threshold, and an individual occupant temperature threshold.

5. The method of claim 1, wherein the elevator car comprises at least a camera or a microphone, the method further comprising:
determining, via the one or more sensors, that at least one passenger health threshold is met; and
initiating communication, using the camera or the microphone, between a passenger of the elevator car and an emergency personnel in response to determining that the at least one passenger health threshold is met.

6. The method of claim 1, further comprising:
determining via one or more cameras a presence and a number of occupants at a landing following a car call;
predicting a car requirement based on the presence and the number of occupants at the landing; and
dispatching a nearest elevator car that satisfies the predicted car requirement when multiple cars are available.

7. The method of claim 1, further comprising:
monitoring, by a plurality of cameras, an area associated with one or more landings adjacent to an elevator shaft along which the elevator car travels; and
determining the route for the elevator car based at least in part on camera data.

8. The method of claim 7, wherein training the AI model further comprises training the AI model with the camera data and archived data from the cameras.

9. The method of claim 8, further comprising sending updated camera data to the AI model each time the elevator car stops at a landing.

10. The method of claim 1, further comprising sending updated camera data and updated sensor data to the AI model each time the elevator car stops at a landing.

11. An elevator control system comprising:
a processor; and
a non-transitory computer readable storage medium storing code, the code being executable by the processor to perform operations comprising:
receiving, from one or more sensors, sensor data associated with an elevator car;
training an artificial intelligence (“AI”) model with a set of preset parameters, the sensor data, archived data from the one or more sensors and corresponding archived data depicting a historical route traveled by the elevator car;
determining, via the AI model, a route for the elevator based at least in part on the sensor data, wherein the determined route is a shortest route that satisfies the set of preset parameters; and
transporting the elevator car according to the determined route.

12. The elevator control system of claim 11, the operations further comprising:
resolving a route planning conflict associated with a sensor malfunction or contradictory sensor information,
wherein resolving the route planning conflict comprises determining a shortest route with a minimal number of stops based on a position of the elevator car, a quantity of humans detected by the one or more sensors and one or more location of humans detected by the one or more sensors in keeping with present parameters.

13. The elevator control system of claim 11, wherein the set of preset parameters comprises at least: a weight threshold, a volume threshold, an occupant threshold, and an individual occupant temperature threshold.

14. The elevator control system of claim 11, the operations further comprising:
determining, via the one or more sensors, that at least one passenger health threshold is met; and
initiating communication, using a camera or one or more microphones, between a passenger of the elevator car and an emergency personnel in response to determining that the at least one passenger health threshold is met.

15. The elevator control system of claim 11, the operations further comprising:
determining via one or more cameras a presence and a number of occupants at a landing following a car call;
predicting a car requirement based on the presence and the number of occupants at the landing; and
dispatching a nearest elevator car that satisfies the predicted car requirement when multiple cars are available.

16. The elevator control system of claim 15, wherein training the AI model further comprises training the AI model with camera data and archived data from the cameras.

17. The elevator control system of claim 11, the operations further comprising sending updated camera data and updated sensor data to the AI model each time the elevator car stops at a landing.

18. The elevator control system of claim 11, the operations further comprising:
determining a presence of an incapacitated passenger in the elevator car; and
bypassing one or more scheduled stops and proceeding to a predetermined floor in response to the presence of the incapacitated passenger.

19. An elevator system comprising:
at least one elevator car;
a set of sensors configured to acquire sensor data associated with the at least one elevator car; and
a controller operative to:
train an artificial intelligence (“AI”) model with a set of preset parameters, archived data from the one or more sensors and corresponding archived data depicting a historical route traveled by the at least one elevator car;
determine, via the AI model, a route for the elevator car based at least in part on the sensor data, wherein the determined route is a shortest route that satisfies the set of preset parameters; and
transport the elevator car according to the determined route.

20. The elevator system of claim 19, wherein the elevator system comprises a multi-shaft elevator configuration having horizontal, diagonal, curved, or vertical physical configurations.
